(19) United States
(12) Patent Application Publication
(10) Pub. No.: US 2006/0152930 A1
(43) Pub. Date: Jul. 13, 2006

(54) Adjustable light-emitting device for projection system

(75) Inventors: Chia-Jui Lin, Taipei City (TW); Mao-shan Hsu, Taipei City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Delta Electronics, Inc., Taoyuan (TW)

(21) Appl. No.: 11/325,047

(22) Filed: Jan. 4, 2006

(30) Foreign Application Priority Data
Jan. 10, 2005 (TW) 94200493

(51) Int. Cl. G03B 21/20; F21V 19/02

(52) U.S. Cl. 362/285; 353/87

(57) ABSTRACT

A light source device for a projection system is provided. The light source device includes a base, a frame, a light-emitting element and an eccentric element, wherein the frame has a pivot connected to the base; the light-emitting element is contained in the frame and provides a light source for the projection system; the eccentric element is mounted on the frame and props the frame, wherein when the eccentric element has a specific movement, the frame will be swung with the pivot and the light-emitting element will be moved accordingly so as to adjust a focal position of the light source device.

### FIELD OF THE INVENTION

This invention relates to a light-emitting device for a projection system, and more particular to an adjustable light-emitting device for a projection system.

### BACKGROUND OF THE INVENTION

The projection system is widely used in various fields. Principally, the light emitted from the light-emitting device (i.e. the lamp) for the projection system is separated as red, green and blue lights, the three primary colors, by the spectroscope, and then the diverted lights are emerged for presenting the optical images required, where the brightness and evenness of the light provided by the light-emitting device play an important role therein. Hence, in respect of providing much better imaging quality for the projection system, the adjustment for the light-emitting device is as important as the optical lens therein.

Please refer to FIG. 1, which illustrates a schematic view of a light-emitting device for the projection system in the prior art. As shown in FIG. 1, the light-emitting device 10 includes a lamp 11, a screw 12 and a frame 13. The fore part of the lamp 11 is directly fixed to the frame 13 by the screw 12 and the lamp 11 is indirectly set in a projection system (not shown) by the frame 13. In such case, the illuminating area of the lamp 11 is not adjustable. Hence, once the lamp 11 is set onto the projection system with it's illuminating area being not ideal, the light-emitting device 10 must be reassembled.

Please refer to FIG. 2, which illustrates a schematic view of the sequential color recapture technique for improving the illuminating efficacy of a light-emitting device for a projection system in the prior art. As shown in FIG. 2, the sequential color recapture technique is applied to a projection system 21, wherein the projection system 21 includes the lamp 25 with a collector to collect and guide the light in a specific direction to a focal position. Along the direction, the light tunnel element 22 is located next to the lamp 25 so that the lamp 25 faces the light entrance end 23 of the light tunnel element 22. The inner surface of the light entrance end 23 of the light tunnel element 22 is mounted with the reflective mirror 24 for recovering the light by the reflection thereof, where the light emitted from the lamp 25 could only enter the light tunnel element 22 through the small hole 26 in the center thereof. Such technique could efficiently improve the illuminating efficacy of the light-emitting device (i.e. the lamp 25) for the projection system 21, but the focal position of light emitted from the lamp 25 must precisely be the same with the hole 26 for decreasing the loss of the entrance of the light. Since the light-emitting device for a projection system in the prior art could not elastically adjust the illuminating area thereof (i.e. precisely adjusting the focal position of light with the hole 26 of the light tunnel element 22), the application of the sequential color recapture technique in the conventional light-emitting device for a projection system still has it's limitation.

Please refer to FIG. 3, which illustrates a schematic view of a plane adjustment device for a lamp in the Taiwan patent application numbered 91220106. The lamp adjustment device 3 mainly includes a base 31, an adjustment module 32, a cover 33 and a lamp 34 connected to the adjustment module 32. The base 31 includes a plurality of y-axial guiding slots 311, a y-axial adjustment element 312 and an x-axial adjustment element 314, wherein each of the y-axial guiding slots 311 is equipped with a spring 313. The adjustment module 32 includes a y-axial adjustment plane 321 and an x-axial adjustment plane 322, wherein the x-axial adjustment plane 322 includes a plurality of x-axial guiding pillars 3221, and the y-axial adjustment plane 321 includes a plurality of y-axial guiding pillars 3211 and a plurality of x-axial guiding slots 3212.

By the cooperation of the y-axial guiding slots 311 with the spring 313 thereof, the y-axial adjustment element 312 and the y-axial guiding pillars 3211, the position of the lamp 34 could be adjusted along the y-axial through the action of the y-axial adjustment element 312. Similarly, by the cooperation of the x-axial guiding pillars 3221, x-axial guiding slots 3212 and the x-axial adjustment element 314, the position of the lamp 34 could be adjusted along the x-axial through the action of the x-axial adjustment element 314.

Such design achieves the goal of adjusting the illuminating-area of a light-emitting device for a projection system and is good for the adjustment of the focal position of the light emitted from the light-emitting device, thereby decreasing the luminance loss. However, such design only provides the adjustment for the illuminating area of a light-emitting device along the axes (the x-axial and the y-axial). Hence, the adjustment preciseness has limitation. In addition, the mentioned adjustment module 32 of the lamp adjustment device 3 is complicated, and the manufacture of the elements thereof requires much time and (or) work. Therefore, the mentioned adjustment device 3 has application limitation and desirably to be improved in lots of aspects.

Because of the technical defects described above, the applicant keeps on carving unflaggingly to develop “an adjustable light-emitting device for a projection system” through wholehearted experience and research.

### SUMMARY OF THE INVENTION

In accordance with an aspect of the present invention, a light source device for a projection system is provided. The light source device includes a base, a frame, a light-emitting element and an eccentric element, wherein the frame has a pivot connected to the base; the light-emitting element is contained in the frame and provides a light source for the projection system; the eccentric element is mounted on the frame and props the frame, wherein when the eccentric element has a specific movement, the frame will be swung with the pivot and the light-emitting element will be moved accordingly so as to adjust a focal position of the light source device.

Preferably, the eccentric element is a cam.

Preferably, the eccentric element is a screw.

Preferably, the light source device further includes a resilient element mounted between the base and the frame.

Preferably, the resilient element is one of a spring and a leaf spring.

Preferably, the light source device further includes a first unidirectional adjusting element mounted on a first side of the base along a first direction, wherein an end of the first unidirectional adjusting element props the frame.

Preferably, the light source device further includes a second unidirectional adjusting element mounted on a second side of the base along a second direction, wherein an end of the second unidirectional adjusting element props the frame, and the first and the second directions are perpendicular to each other.

Preferably, each of the first and the second unidirectional adjusting elements is one of a guiding bar and an adjusting screw.

Preferably, the base further has an air duct mounted on a position thereof corresponding to the pivot for swinging with the light-emitting element.

In accordance with the other aspect of the present invention, a light source device for a projection system is provided. The light source device includes a base, a light-emitting device and an eccentric element, wherein the light-emitting device for providing a light source for the projection system includes a pivot mounted to the base; the eccentric element is mounted on the base and propping the light-emitting device, wherein by a specific movement of the eccentric element, the light-emitting device will be swung with the pivot so as to adjust a focal position of the light source device.

Preferably, the eccentric element is a cam.

Preferably, the eccentric element is a screw.

Preferably, the light source device further includes a resilient element connected between the base and the light-emitting device.

Preferably, the resilient element is one of a spring and a leaf spring.

Preferably, the light source device further includes a first unidirectional adjusting element mounted on a first side of the base along a first direction, wherein an end of the first unidirectional adjusting element props the light-emitting device.

Preferably, the light source device further includes a second unidirectional adjusting element mounted on a second side of the base along a second direction, wherein an end of the second unidirectional adjusting element props the light-emitting device, and the first and the second direction are perpendicular to each other.

Preferably, each of the first and the second unidirectional adjusting elements is one of a guiding bar and an adjusting screw.

Preferably, the base further has an air duct mounted on a position thereof corresponding to the pivot for swinging with the light-emitting element.

In accordance with another aspect of the present invention, an adjustment device for a light-emitting element of a projection system is provided. The adjustment device includes a base, a frame, and an eccentric element, wherein the frame has a shaft mounted on the base; the eccentric element is mounted on the frame and propping the frame, wherein by a specific movement of the eccentric element, the frame will be swung with the shaft and the light-emitting element is moved accordingly so as to adjust a focal position of the light-emitting element.

Preferably, the eccentric element is a cam.

Preferably, the eccentric element is a screw.

Preferably, the adjustment device further includes a resilient element connected between the base and the frame.

Preferably, the resilient element is one of a spring and a leaf spring.

Preferably, the adjustment device further includes a first unidirectional adjusting element mounted on a first side of the base along a first direction, wherein an end of the first unidirectional adjusting element props the frame.

Preferably, the adjustment device further includes a second unidirectional adjusting element mounted on a second side of the base along a second direction, wherein an end of the second unidirectional adjusting element props the frame, and the first and the second directions are perpendicular to each other.

Preferably, each of the first and the second unidirectional adjusting elements is one of a guiding bar and an adjusting screw.

Preferably, the base further has an air duct mounted on a position thereof corresponding to the shaft for swinging with the light-emitting element of the projection system.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 shows a schematic view of a light-emitting device for the projection system in the prior art;

FIG. 2 shows a schematic view of the sequential color recapture technique for improving the illuminating efficacy of a light-emitting device for a projection system in the prior art;

FIG. 3 shows a schematic view of a plane adjustment device for a lamp in the Taiwan patent application numbered 91220106;

FIGS. 4 and 5 respectively show the lateral and frontal views (along the light emitting path) of the light source device for a projection system in the first embodiment according to the present invention; and

FIGS. 6 and 7 respectively show the stereo and lateral views of the light source device for a projection system in the second embodiment according to the present invention.

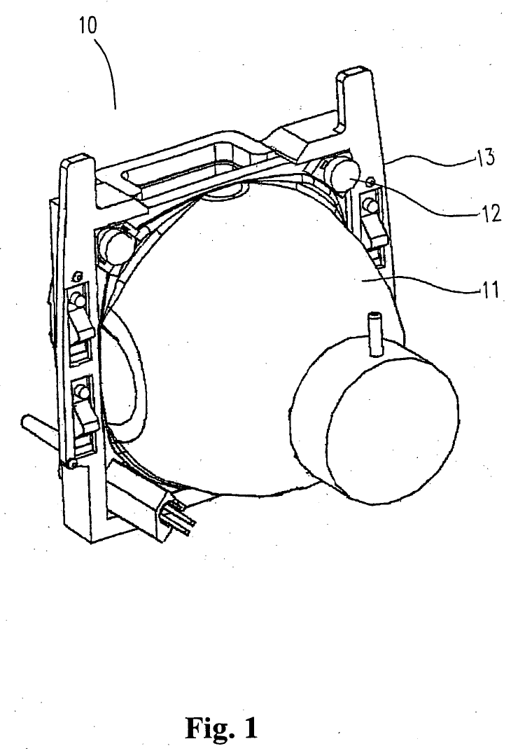

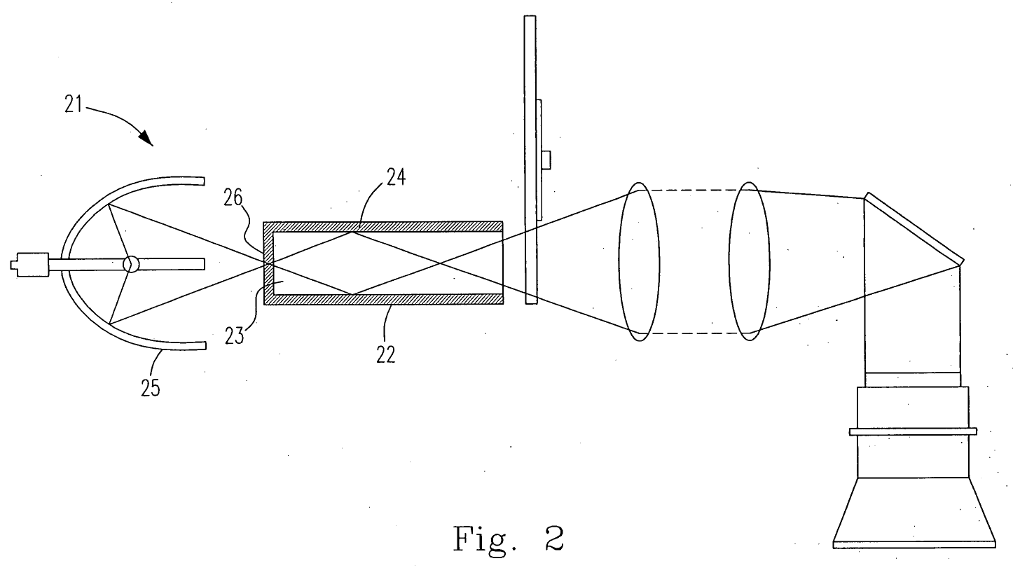

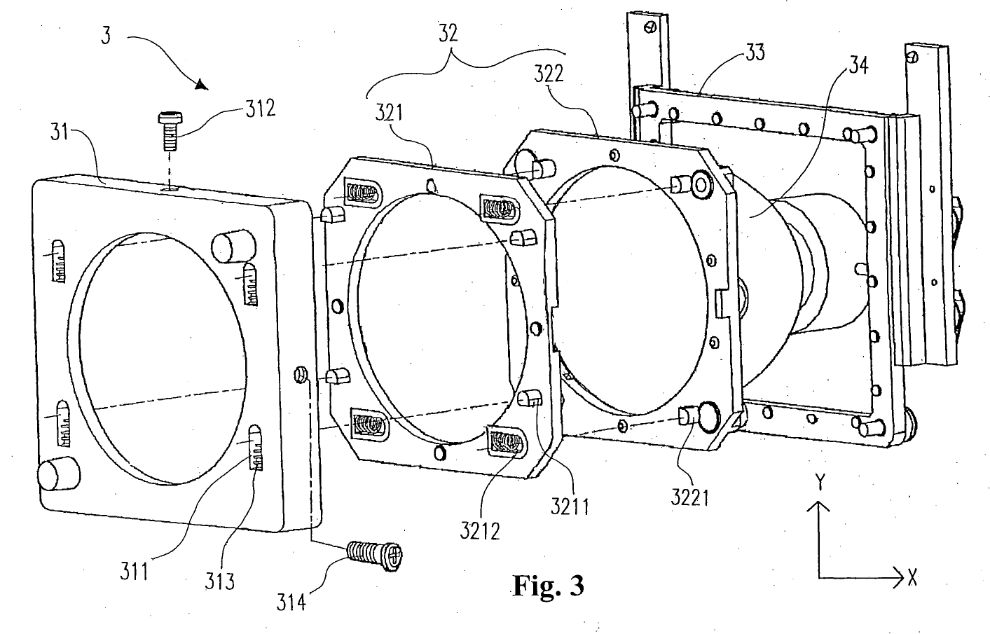

### DETAILED DESCRIPTION OF THE PREFERRED EMBODIMENT

The present invention will now be described more specifically with reference to the following embodiments. It is to be noted that the following descriptions of preferred embodiments of this invention are presented herein for purposes of illustration and description only; it is not intended to be exhaustive or to be limited to the precise form disclosed.

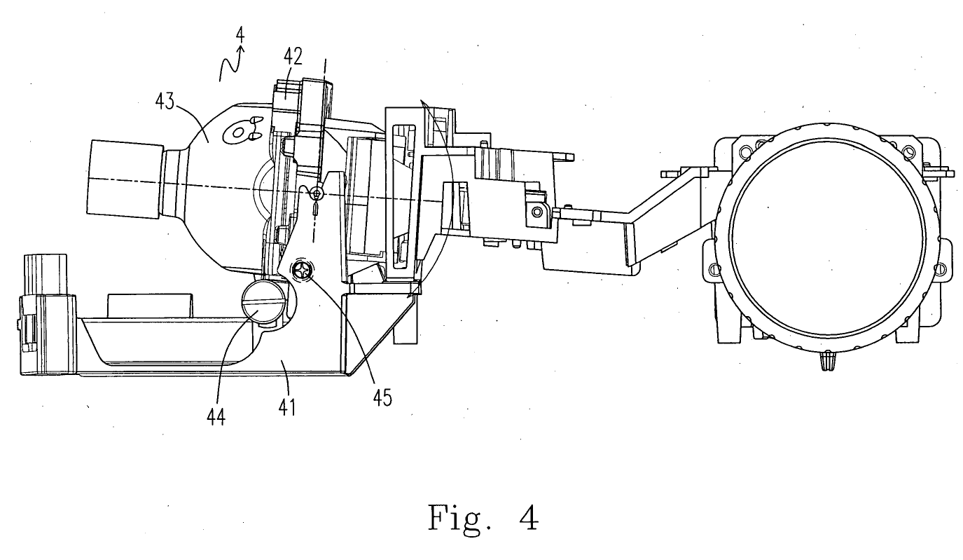

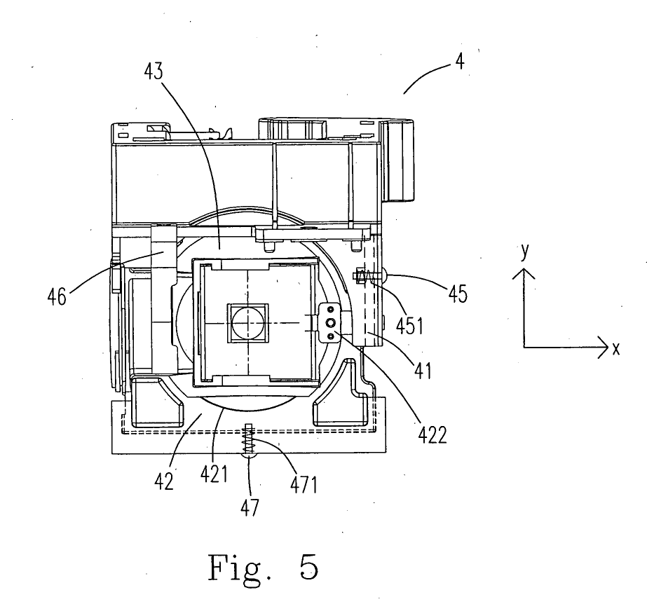

Please refer to FIGS. 4 and 5, which respectively illustrate the lateral and frontal views (along the light emitting path) of the light source device for a projection system in the first embodiment according to the present invention. The light source device 4 includes a base 41, a frame 42, a lamp 43 and an eccentric element 44, wherein the frame 42 has a pivot 422 connected to the base 41 and a container 421 for containing the lamp 43 therein; the eccentric element 44 is mounted on a side of the base 41 for propping the frame 42. While the eccentric element 44 has a specific movement, the frame 42 will be swung with the pivot 422 (since the frame 42 is pivotally connected to the base 41 and the eccentric element 44 props the frame 42), and the lamp 43 contained in the frame 42 will be moved accordingly so as to adjust a focal position of the light source device 4.

In addition, since the eccentric element 44 has an asymmetry axle, the rotation of the eccentric element 44 in the present light source device 4 will consequently drive the lamp 43 in FIG. 5 to swing along the y-axis for more precisely adjusting the illuminating area of the light source (i.e. the lamp 43).

The light source device 4 further includes a first unidirectional adjusting element 45 mounted on a side of the base 41 along a first direction (along the x-axis shown in FIG. 5), wherein the first unidirectional adjusting element 45 passes through the base 41 and an end thereof props the frame 42. With the adjustment of the first unidirectional adjusting element 45, the frame 42 shifts along the x-axis, and thus the illuminating area of the light emitted from the lamp 43 also shifts along the x-axis. Further, the light source device 4 includes a second unidirectional adjusting element 47 mounted on another side of the base 41 along a second direction (along the y-axis shown in FIG. 5), wherein the second unidirectional adjusting element 47 passes through the base 41 and an end thereof props the frame 42. With the adjustment of the second unidirectional adjusting element 47, the frame 42 shifts along the y-axis, and thus the illuminating area of the light emitted from the lamp 43 also shifts along the y-axis. Hence, the actions of the first and the second unidirectional adjusting elements 45 and 47 provide further adjustment of the illuminating area of the light source device 4 along the axes for more precisely adjusting the illuminating area of the light source.

It should be noted that the eccentric element 44 could be an eccentric cam or an eccentric screw; each of the first and the second unidirectional adjusting elements 45 and 47 could be a guiding bar or an adjusting screw with spring (451 or 471). The resilience of the spring 451 or 471 would enable the frame 42 to slightly shift in an opposite direction, and the focal position of the light source device 4 will shift accordingly so as to provide a slight adjustment for the light source device 4 along the axes for better adjusting accuracy.

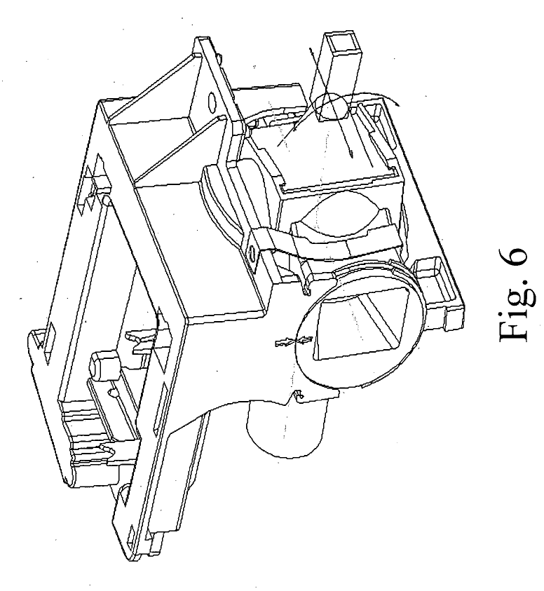

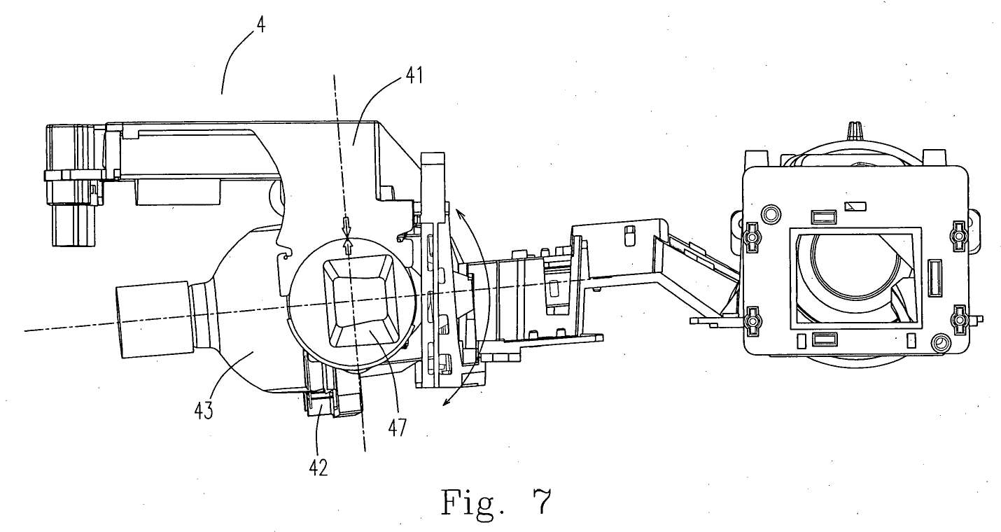

It is preferred that the light source device 4 further includes a resilient element 46, which could be a spring or a leaf spring. One end of the resilient element 46 is mounted on the base 41 and the other end thereof props the frame 42. While the frame 42 swings with the rotation of the eccentric element 44, it props the resilient element 46 and the generated resilience of the resilient element 46 would enable the frame 42 to slightly shift in an opposite direction. Hence the accuracy of the adjustment is further increased. Please refer to FIGS. 6 and 7, which respectively illustrate the stereo and lateral views of the light source device for a projection system in the second embodiment according to the present invention. Compared with the embodiment described in FIG. 5, the light-source device 4 illustrated either in FIG. 6 or FIG. 7 further includes an air duct 47. The air duct 47 is mounted on the base 41 in a position corresponding to that of the lamp 43, which is contained in the frame 42, for cooling the lamp 43. The air duct 47 swings with the lamp 43 for providing the ideal cooling effect whenever the light source device 4 is adjusted.

Certainly, the isolated frame mentioned above could be incorporated with the lamp in the light source device for minimizing the size of a projection system. That is to say, it is also preferred that the eccentric element and the resilient element mentioned above directly prop the lamp for precise adjustment of the illuminating area (focal position) thereof.

Hence, the present invention provides a simple adjustment device which works in a simpler way for precisely adjusting the illuminating area or focal position of a light source device for a projection system. Besides improving the brightness and the evenness of light emitted from a light source device for a projection system achieved by the present invention, the air duct thereof also provides ideal heat dissipating for the light source device in a projection system. Moreover, the design of the present invention is simple and easy for industrial production. Hence, the present invention not only has novelty and progressive nature, but also has an industrial utility.

Thus, compared with the prior art, the present invention is more practical, more effective, simpler and easier for operating. And, most importantly, the present invention is used more potentially than the prior art.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A light source device for a projection system, comprising:
a base;
a frame having a pivot connected to the base;
a light-emitting element contained in the frame and providing a light source for the projection system; and
an eccentric element mounted on the frame and propping the frame,
wherein when the eccentric element has a specific movement, the frame will be swung with the pivot and the light-emitting element will be moved accordingly so as to adjust a focal position of the light source device.

2. The light source device according to claim 1, wherein the eccentric element is a cam.

3. The light source device according to claim 1, wherein the eccentric element is a screw.

4. The light source device according to claim 1, further comprising a resilient element mounted between the base and the frame.

5. The light source device according to claim 4, wherein the resilient element is one of a spring and a leaf spring.

6. The light source device according to claim 1, further comprising a first unidirectional adjusting element mounted on a first side of the base along a first direction, wherein an end of the first unidirectional adjusting element props the frame.

7. The light source device according to claim 6, further comprising a second unidirectional adjusting element mounted on a second side of the base along a second direction, wherein an end of the second unidirectional adjusting element props the frame, and the first and the second directions are perpendicular to each other.

8. The light source device according to claim 7, wherein each of the first and the second unidirectional adjusting elements is one of a guiding bar and an adjusting screw.

9. The light source device according to claim 1, wherein the base further has an air duct mounted on a position thereof corresponding to the pivot for swinging with the light-emitting element.

10. A light source device for a projection system, comprising:
a base;
a light-emitting device for providing a light source for the projection system and comprising a pivot mounted to the base; and
an eccentric element mounted on the base and propping the light-emitting device,
wherein by a specific movement of the eccentric element, the light-emitting device will be swung with the pivot so as to adjust a focal position of the light source device.

11. The light source device according to claim 10, wherein the eccentric element is a cam.

12. The light source device according to claim 10, wherein the eccentric element is a screw.

13. The light source device according to claim 10, further comprising a resilient element connected between the base and the light-emitting device.

14. The light source device according to claim 13, wherein the resilient element is one of a spring and a leaf spring.

15. The light source device according to claim 10, further comprising a first unidirectional adjusting element mounted on a first side of the base along a first direction, wherein an end of the first unidirectional adjusting element props the light-emitting device.

16. The combination structure according to claim 15, further comprising a second unidirectional adjusting element mounted on a second side of the base along a second direction, wherein an end of the second unidirectional adjusting element props the light-emitting device, and the first and the second direction are perpendicular to each other.

17. The light source device according to claim 16, wherein each of the first and the second unidirectional adjusting elements is one of a guiding bar and an adjusting screw.

18. The light source device according to claim 10, wherein the base further has an air duct mounted on a position thereof corresponding to the pivot for swinging with the light-emitting element.

19. An adjustment device for a light-emitting element of a projection system, comprising:
a base;
a frame having a shaft mounted on the base; and
an eccentric element mounted on the frame and propping the frame,
wherein by a specific movement of the eccentric element, the frame will be swung with the shaft and the light-emitting element is moved accordingly so as to adjust a focal position of the light-emitting element.

20. The adjustment device according to claim 19, wherein the eccentric element is a cam.

21. The adjustment device according to claim 19, wherein the eccentric element is a screw.

22. The adjustment device according to claim 19, further comprising a resilient element connected between the base and the frame.

23. The adjustment device according to claim 22, wherein the resilient element is one of a spring and a leaf spring.

24. The adjustment device according to claim 19, further comprising a first unidirectional adjusting element mounted on a first side of the base along a first direction, wherein an end of the first unidirectional adjusting element props the frame.

25. The adjustment device according to claim 24, further comprising a second unidirectional adjusting element mounted on a second side of the base along a second direction, wherein an end of the second unidirectional adjusting element props the frame, and the first and the second directions are perpendicular to each other.

26. The adjustment device according to claim 25, wherein each of the first and the second unidirectional adjusting elements is one of a guiding bar and an adjusting screw.

27. The adjustment device according to claim 19, wherein the base further has an air duct mounted on a position thereof corresponding to the shaft for swinging with the light-emitting element of the projection system.
